(19) United States
(12) Patent Application Publication
(10) Pub. No.: US 2002/0178101 A1
(43) Pub. Date: Nov. 28, 2002

(54) System and method for option pricing using a modified black scholes option pricing model

(76) Inventor: Lawrence W. Swift, Germantown, MD (US)

Correspondence Address: ROBERTS, ABOKHAIR & MARDULA, LLC, Suite 1000, 11800 SUNRISE VALLEY DRIVE, RESTON, VA, 20191, US

(21) Appl. No.: 10/153,751

(22) Filed: May 22, 2002

Related U.S. Application Data
(60) Provisional application No. 60/293,372, filed on May 24, 2001.

(51) Int. Cl. G06F 17/60

(52) U.S. Cl. 705/36

(57) ABSTRACT

A modified Black-Scholes algorithm used for pricing options. While the Black-Scholes algorithm has been a mainstay in the financial world, its assumptions do not accurately reflect the marketplace of long-term options, and other securities and assets. Since markets tend to rise over time, the existing Black-Scholes algorithm tends to underprice and undervalue options and other securities due to the model's assumption of normal distribution. The system and method of the present invention corrects for assumptions in the Black-Scholes Algorithm by accounting for the long-term bias of markets to increase over the long-term.

### RELATED APPLICATIONS

This application claims the benefit of the U.S. Provisional Application No. 60/293,372, filed May 24, 2001, entitled “System and Method for Option Pricing Using a Modified Black-Scholes Pricing Model” and naming Lawrence W. Swift as inventor.

### FIELD OF THE INVENTION

This invention relates generally to the fields of finance and investment. More particularly, this invention comprises a system and method for determining the value of long-term options by correcting the Black-Scholes pricing model to reflect the propensity of a stock price to change over the long term.

### BACKGROUND OF THE INVENTION

The idea of options is certainly not new. Ancient Romans, Grecians, and Phoenicians traded options against outgoing cargoes from their local seaports. When used in relation to financial instruments, options are generally defined as a “contract between two parties in which one party has the right but not the obligation to do something, usually to buy or sell some underlying asset”. Having rights without obligations has financial value, so option holders must purchase these rights, making them assets. This asset derives their value from some other asset, so they are called derivative assets. “Call” options are contracts giving the option holder the right to buy something, while “put” options, conversely, entitle the holder to sell something. Payment for call and put options, takes the form of a flat, up-front sum called a premium. Options can also be associated with bonds (i.e. convertible bonds and callable bonds), where payment occurs in installments over the entire life of the bond.

Modern option pricing techniques, with roots in stochastic calculus, are often considered among the most mathematically complex of all applied areas of finance. These modern techniques derive their impetus from a formal history dating back to 1877, when Charles Castelli wrote a book entitled “The Theory of Options in Stocks and Shares”. Castelli's book introduced the public to the hedging and speculation aspects of options, but lacked any monumental theoretical base.

One of the earliest efforts to refine the valuation of options was made in 1900 by Louis Bachelier who offered the earliest known analytical valuation for options in his Ph.D. mathematics dissertation [“Theorie de la Speculation”] at the Sorbonne. Unfortunately, his formula was based on unrealistic assumptions, including a zero interest rate, and a process that allowed for a negative share price. Bachelier's work interested a professor at MIT named Paul Samuelson, who in 1955, wrote an unpublished paper entitled “Brownian Motion in the Stock Market”. During that same year, Richard Kruizenga, one of Samuelson's students, cited Bachelier's work in his dissertation entitled “Put and Call Options: A Theoretical and Market Analysis”. In 1964 Case Sprenkle, James Boness and Paul Samuelson improved on Bachelierís formula. They assumed that stock prices are log-normally distributed (which guarantees that share prices are positive) and allowed for a non-zero interest rate. They also assumed that investors are risk averse and demand a risk premium in addition to the risk-free interest rate. Boness' formula came close to the Black-Scholes model, but still relied on an unknown interest rate, which included compensation for the risk associated with the stock.

The attempts at valuation before 1973 basically determined the expected value of a stock option at expiration and then discounted its value back to the time of evaluation. Such an approach requires taking a stance on which risk premium to use in the discounting. This is because the value of an option depends on the risky path of the stock price, from the valuation date to maturity. But assigning a risk premium is not straightforward. The risk premium should reflect not only the risk for changes in the stock price, but also the investor's attitude towards risk. And while the latter can be strictly defined in theory, it is hard or impossible to observe in reality.

In 1973 Fischer Black and Myron S. Scholes published the famous option pricing formula that now bears their name (Black and Scholes (1973)). They worked in close cooperation with Robert C. Merton, who, that same year, published an article which also included the formula and various extensions (Merton (1973)). The “Black-Scholes” pricing model has subsequently been recognized as the default method of the options market for valuing all options. The Black-Scholes algorithm is incorporated into almost all “option pricing calculators” and is the default method for determining pricing in the options market. The Black-Scholes algorithm (for the price of a “Call” option (option to buy)) is as follows:

C=SN(d)−Le^{-rt}N(d−σ√\vec{t})

where the variable d is defined by

$$d = \frac{ln \frac{S}{L} + ( r + \frac{{σ}^{2}}{2} ) t}{σ \sqrt{t}}$$

According to this formula, the value of the call option C, is given by the difference between the expected share value—the first term on the right-hand side—and the expected cost—the second term—if the option right is exercised at maturity. The formula says that the option value is higher the higher the share price today S, the higher the volatility of the share price (measured by its standard deviation) sigma, the higher the risk-free interest rate r, the longer the time to maturity t, the lower the strike price L, and the higher the probability that the option will be exercised (the probability is evaluated by the normal distribution function N).

The Black-Scholes model has become indispensable in the analysis of many economic problems. Derivative securities constitute a special case of so-called contingent claims and the valuation method can often be used for this wider class of contracts. The value of the stock, preferred shares, loans, and other debt instruments in a firm depends on the overall value of the firm in essentially the same way as the value of a stock option depends on the price of the underlying stock. The Black-Scholes model is becoming the foundation for a unified theory of the valuation of corporate liabilities.

A guarantee gives the right, but not the obligation, to exploit it under certain circumstances. Anyone who buys or is given a guarantee thus holds a kind of option. The same is true of an insurance contract. The Black-Scholes model can therefore be used to value guarantees and insurance contracts. One can thus view insurance companies and the option market as competitors.

Investment decisions constitute another application of the Black-Scholes model. Many investments in equipment can be designed to allow more or less flexibility in their utilization. Examples include the ease with which one can close down and reopen production (in a mine, for instance, if the metal price is low) or the ease with which one can switch between different sources of energy (if, for instance, the relative price of oil and electricity changes). Flexibility can be viewed as an option. To choose the best investment, it is therefore essential to value flexibility in a correct way. The Black-Scholes model has made this feasible in many cases.

Banks and investment banks regularly use the Black-Scholes methodology to value new financial instruments and to offer instruments tailored to their customers' specific risks. At the same time such institutions can reduce their own risk exposure in financial markets.

Thus, the term “option” as used herein is not limited to stock options but encompasses a broad range of rights which can be expressed in financial terms. For sake of clarity, the term “option” will be used to encompass this broad definition unless specifically qualified by other terms or the context in which it appears.

The Black-Scholes model incorporates several simplifying assumptions some of which are not realistic in certain cases. The most significant of these assumptions isthe assumption of normal distribution of possible outcomes with the use of the normal distribution function in the Black-Scholes model. With respect to stock options, this assumption suggests that logarithmic returns on the underlying stock are normally distributed with stock prices following a geometric Wiener process. This assumption may be realistic over the short-term, but is not realistic over the long run. The essence of the assumption is that the value of any given stock can be said to be as likely to go up tomorrow as it is to go down. However, history has proven that, in general, a stock is not as likely to be down from its current price over the long-term. For long-term stock options, the effect of this faulty assumption is significant and causes the Black-Scholes model to undervalue long-term stock options. Similarly, the Black-Scholes model incorrectly values (either by overstating or understating the value) any asset for which the normal distribution assumption is incorrect.

What is needed, therefore, is a more accurate method of pricing long-term options that adequately reflects the propensity of the price of the asset underlying the option to change over the long term thereby correcting the valuation determined by application of the Black-Scholes model.

### SUMMARY OF THE INVENTION

It is an object of the present invention to identify under-priced long-term assets.

It is a further object of the present invention to improve option pricing models to reflect the realities of market bias.

It is yet another object of the present invention to more accurately identify when to buy an under-priced asset.

It is still another object of the present invention to be able to more accurately identify when to sell an over-priced asset.

It is a further object of the present invention to correct the existing pricing model for options using an accurate mathematical description of the market over time.

It is still another object of the present invention to modify the existing option pricing model with a mathematical description of the progress of a particular sector of the market over time.

These and other objectives of the present invention will become apparent to those skilled in the art by a review of the detailed description that follows. In the present invention, the value of an option over the long term is determined more accurately by correcting the valuation determined by using the Black-Scholes model by applying a correction factor to this valuation methodology that reflects the propensity of the underlying asset to increase or decrease over time in the long term. This correction factor is based on market data relevant to the asset underlying the option under evaluation. The correction can be either in the addition to the Black-Scholes model of an additional factor to incorporate market bias or, more likely, the changing of one of the elements in the Black-Scholes model to reflect this bias (i.e. the “volatility” element).

In one embodiment of the present invention, the option for which the value is to be determined is a stock option (a call). Application of the Black-Scholes model to stock options produces a value referred to as the premium value. In this embodiment, the correction factor reflects the propensity of the price of the stock underlying the option to increase or decrease during the period that the option is being valued (herein, the “bias” of the stock or asset). Bias is a function of the slope of the non-normal distribution of the price of the asset underlying the option over time. One way to derive the bias for a particular stock option is to determine the bias of the index curve in which the underlying stock is listed. Another measure of bias is the bias of an industry-specific index selected based on the industry group to which the company whose stock underlies the option being evaluated belongs. Another measure of bias is the historical performance of the asset itself over time.

In another embodiment, the option under evaluation is any set of rights that (a) can be evaluated using the Black-Scholes model, and (b) is associated with data that can be used to determine the bias of the asset underlying the option over time. In this embodiment, the value over the long term of insurance contracts, asset portfolios, asset procurements, and a host of other business decisions can be evaluated.

### BRIEF DESCRIPTION OF THE DRAWINGS

FIG. 1 illustrates a normal distribution in statistics.

FIG. 2 illustrates the standard deviation of a number of datapoints about a mean.

FIG. 3 illustrates a normal distribution of possible outcomes for future stock prices.

FIG. 4 illustrates a more accurate representation of the historical reality of equities over time.

FIG. 5 illustrates the implied volatility over option duration for all traded call options of the Motorola, Corp. (NYSE symbol “MOT”) on May 15, 1998.

FIG. 6 illustrates the implied volatility over option duration for all traded call options of the Motorola, Corp. (NYSE symbol “MOT”) on May 15, 1998 adjusted using a bias factor.

### DETAILED DESCRIPTION OF THE INVENTION

As noted above, the present invention comprises a system and method for determining the value of long-term options by correcting the Black-Scholes pricing model to reflect the propensity of the asset underlying the option to change over the long term. To illustrate the present invention, the following discussion applies the Black-Scholes pricing model to price a European call option, however this means of illustrating the present invention is not meant as a limitation. As will be apparent to one skilled in the art of the present invention, the present invention can be applied to any set of rights where the Black-Scholes pricing model is used and where the bias of the asset underlying the set of rights can be determined.

When applied to stock options, the Black-Scholes algorithm assumes normal distribution of possible outcomes over time. This assumption may be realistic over the short-term, but is not realistic over the long run. That is to say, the value of any given stock can be said to be as likely to go up tomorrow as it is to go down. However, history has proven that, in general, a stock is not as likely to be down from its current price over the long-term as it is to be up. The result of the assumption is that long-term options priced using the Black-Scholes model are undervalued.

A review of the Dow Jones Industrial average will illustrate this conclusion. Going back in time to the 1930's, one would notice that over the long run, stock prices have a positive bias, meaning that they go up in value over the long-term. Again, this is contrary to the assumption of the Black-Scholes model which assumes a normal distribution of possible outcomes (i.e. as likely to go up as it is to go down).

Over the short-run, the likelihood of the Dow Jones Industrial average going up or down is relatively even (a statistical coin toss). However, it is observable that over longer periods of time, the bias for the Dow Jones Industrial average is to increase in value. Herein lies the problem with the Black-Scholes model for pricing long-term options. Since stocks have a positive bias over the long-run, assuming a normal distribution of outcomes is contrary to the reality of the market for long-term assets.

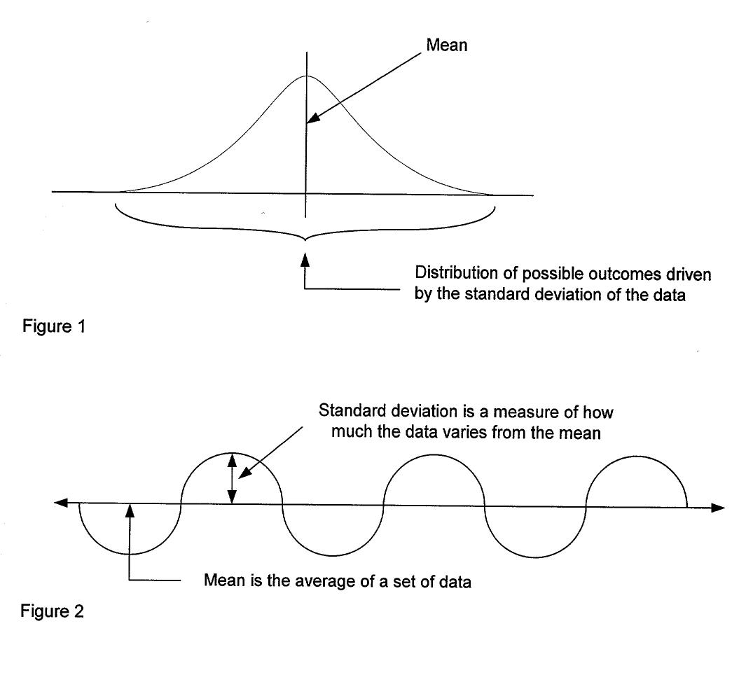

The general description of the problem can be easily comprehended graphically. Referring first to FIG. 1 a normal distribution in statistics is illustrated and is driven by a mean value with a corresponding standard deviation of possible outcomes.

Referring to FIG. 2, the principle that the mean is an average of data points, while the standard deviation is measure of variability from the mean, is illustrated graphically.

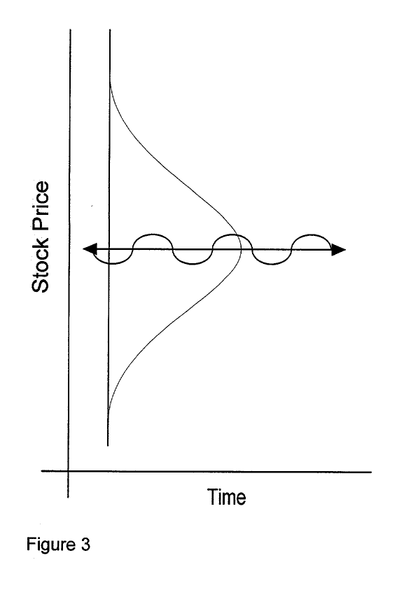

By assuming a normal distribution of possible outcomes, the Black-Scholes model, and its inherent assumptions will generate stock price curve as illustrated in FIG. 3.

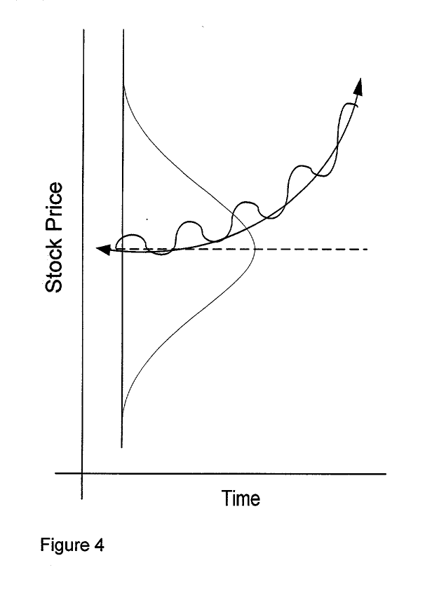

However, accounting for the increase in stock price over a longer period of time yields the stock price curve illustrated in FIG. 4. This graph shows a more accurate representation of the historical reality of equities over time. The slope of the stock price curve is a measure of the bias of the underlying asset.

Over the short-run, normal distribution of future stock prices is not an unrealistic assumption. Stocks fluctuate daily, and there is little evidence to indicate either a positive or negative bias to the day-to-day movements of the market. However, over the long run the markets have demonstrated a significant positive bias (as evidenced by the slope of the stock price versus time curve).

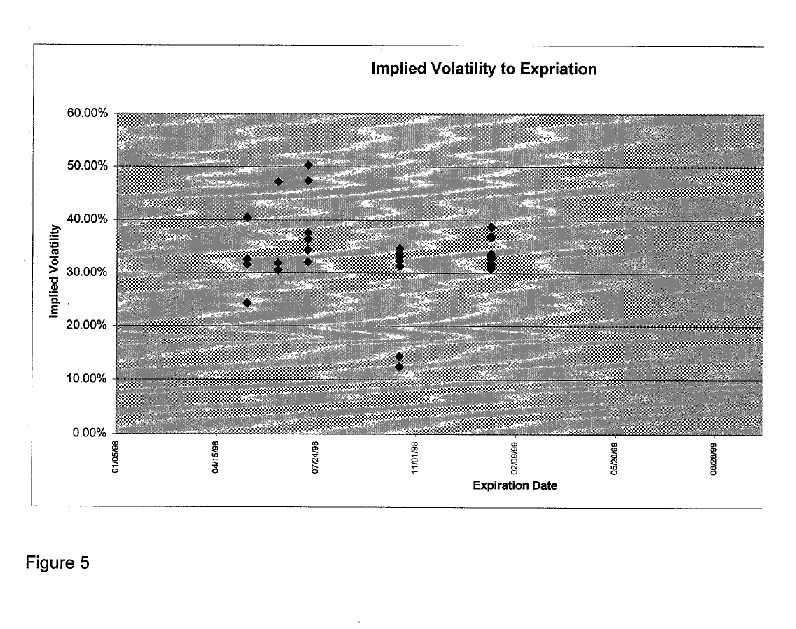

This conclusion can be confirmed by looking at a specific example. Since all of the variables in the Black-Scholes model are independently observable except “volatility” (“sigma” in the model), one would expect that for options (derivatives) of varying expiration windows on the same underlying asset that the volatility (often called “implied volatility”) would be constant. Referring to FIG. 5, the implied volatility over option duration for all traded call options of the Motorola, Corp. (NYSE symbol “MOT”) on May 15, 1998 is illustrated.

It should be noted that there are multiple options for the same expiration (time) point. This is because there can be several different strike prices for an option with the same duration. The important thing to glean from FIG. 5 is that the implied volatility is relatively constant, showing no statistically significant positive bias. (This observation was confirmed by using the sum of least squares technique to fit a line to the data set with the resulting line having a slope of 0.00001.)

These same results are seen in almost all options which trade in volume. This means that options demand no premium for time beyond that included in the Black-Scholes option model for the time value of money. In other words, the model has not assumed a positive bias for longer periods of time to compensate for the non-normal distribution of possible stock prices over longer periods of time. Thus, the Black-Scholes option model tends to undervalue long-term options.

The present invention corrects the deficiency in the Black-Scholes model by modifying the model to reflect the propensity of the stock price to change over the long term. By deriving the bias (slope) of either the entire market (S&P 500, Dow Jones Industrials or other similar indexes), the specific industry (industry specific indexes), the asset itself or any other data set, and applying that slope (bias) to the model (either by adding a bias factor to the Black-Scholes model or increasing the model's existing volatility value for longer-term options), the faulty assumption on which the Black-Scholes model is based is corrected.

In another embodiment present invention, the option under evaluation is any set of rights that can be evaluated using the Black-Scholes model and for which a bias of the asset underlying the option can be determined. By way of example and not as a limitation, the asset under evaluation in this embodiment can be a set or subset of securities and/or assets ranging from a single stock to an entire market (index) or an insurance contract or project. When the asset (stock, contract, project . . . ) being valued has a long-term duration and a bias (either positive or negative) can be established, the present invention can be used to more accurately value the “asset” over the “long-term”.

It should also be noted that what constitutes the “long-term” is determined by the asset under evaluation and the time period over which the normal distribution assumptions of the Black-Scholes model remains accurate. In the context of the present invention, “long-term” means the period after which the price curve of the underlying asset ceases to be accurately represented by a normal distribution of possible outcomes.

In another embodiment of the present invention, the faulty assumption of the Black-Scholes model is corrected by applying a correction factor to the Black-Scholes model. The factor applied to the Black-Scholes model would have the effect of including the bias into the model. Such a factor is a mathematical expression, added to the Black-Scholes model to reflect the bias of the general market (or market segment) as appropriate to the asset under evaluation. A more likely modification to the model is to use the existing Black-Scholes model and change the single non-known variable (sigma or volatility) to reflect the bias over time.

Using the Black-Scholes model, corrected according to the present invention, the more accurate value of the call option is given by the difference between the expected share price and the expected cost if the option is exercised, taking into account the bias of the underlying asset. In essence the value of the call option is higher if the following are true:

The share price goes up

Interest rates go up

The maturity of the option is longer

The strike price is lower

The volatility of the share price (as measured by its standard deviation) sigma goes higher

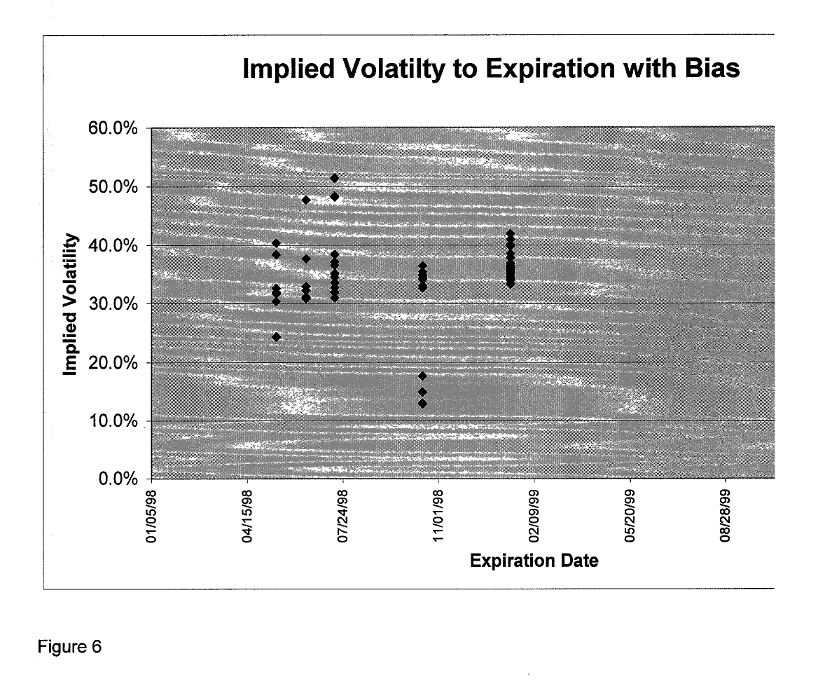

By way of illustration and referring to FIG. 5, the actual Motorola implied volatility data as of May 15, 1998 using the Black-Scholes model is shown. Applying a positive bias to that implied volatility variable (of 12% increase per year compounded daily) results the adjusted implied volatility graph illustrated in FIG. 6, showing a positive bias to the volatility over time. In other words, the actual Motorola call option data as of May 15, 1998 (see FIG. 5) shows no trend (positive or negative), however, the addition of a bias factor (in this case by increasing the volatility factor over time to account for market bias) shows a positive slope to the data. This increase in volatility over time translates into a higher cost of the call option for longer-term expirations to reflect the bias of the market.

As will be apparent to one skilled in the art of the present invention, the implications of correcting the Black-Scholes model for long-term investments are significant. By way of example and not as a limitation, using the present invention, it is possible to more accurately reflect the value of long-term derivative assets, identify under priced assets, identify over priced assets, identify when to buy under priced assets, identify when to sell over priced assets.

In yet another alternative embodiment, the present invention can be used as the basis of an automated computer system comprised of a computer, a database (or link to a data set) and a software package designed to (1) compute the implied volatility of options and (2) compute the market, market segment, company or other bias. With this information, the system can discover under and/or over priced assets. In addition, the system can correctly price longer-term assets. In another alternative embodiment, the system is located on a server and accessed remotely over a network, including but not limited to, wired, wireless, and hybrid networks.

A system and method for pricing of options using a modified Black-Scholes pricing model has now been illustrated. It will be apparent to those skilled in the art that other applications to financial and securities instruments are possible without departing from the scope of the invention as disclosed.

I claim:

1. A method for determining the long-term value of an option comprising:
determining an expected value of the option using the Black-Scholes model; and
adjusting the expected value by applying a factor to the expected value to reflect the propensity of the asset underlying the option to increase or decrease in value over time to determine the long-term value of the option to arrive at an adjusted expected value.

2. The method of claim 1 wherein adjusting the expected value by applying a factor to the expected value to reflect the propensity of the asset underlying the option to increase or decrease in value over time further comprises incorporating an additional argument into the Black-Scholes model.

3. The method of claim 1 wherein adjusting the expected value by applying a factor to the expected value to reflect the propensity of the asset underlying the option to increase or decrease in value over time further comprises adjusting at least one variable of the Black-Scholes model.

4. The method in claim 1 wherein the option is an option to buy or sell stock.

5. The method in claim 1 wherein the option is an insurance policy.

6. The method in claim 4 wherein the factor that reflects the propensity of the asset underlying the option to increase or decrease in value is determined by deriving the slope of a stock market index curve in which the underlying stock is listed.

7. The method of claim 4 wherein the factor that reflects the propensity of the asset underlying the option to increase or decrease in value is determined by deriving the slope of an industry specific stock market index curve representing the industry of the corporation the stock of which is the basis for the option.

8. The method of claim 4 wherein the factor that reflects the propensity of the asset underlying the option to increase or decrease in value is determined by deriving the slope of a curve representing the historical performance over time of the stock of the corporation which is the basis for the option.

9. An option valuation computer, the option evaluation computer comprising:
a processor,
a display device,
a storage device, and
a memory, the memory comprising software instructions, the software instructions comprising instructions for:
determining an expected value of the option using the Black-Scholes model;
adjusting the expected value by applying a factor to the expected value to reflect the propensity of the asset underlying the option to increase or decrease in value over time to determine the value of the option; and
displaying the expected value as adjusted on the display device.

10. The option valuation computer of claim 9 wherein the instructions for adjusting the expected value by applying a factor to the expected value to reflect the propensity of the asset underlying the option to increase or decrease in value over time further comprises instructions for incorporating an additional argument into the Black-Scholes model.

11. The option valuation computer of claim 9 wherein the instructions for adjusting the expected value by applying a factor to the expected value to reflect the propensity of the asset underlying the option to increase or decrease in value over time further comprises instructions for adjusting at least one variable of the Black-Scholes model.

12. The option valuation computer of claim 9 wherein the option is an option to buy or sell stock.

13. The option valuation computer of claim 9 wherein the option is an insurance policy.

14. The option valuation computer of claim 12 wherein the factor that reflects the propensity of the asset underlying the option to increase or decrease in value is determined by deriving the slope of a stock market index curve in which the underlying stock is listed.

15. The option valuation computer of claim 12 wherein the factor that reflects the propensity of the asset underlying the option to increase or decrease in value is determined by deriving the slope of an industry specific stock market index curve representing the industry of the corporation the stock of which is the basis for the option.

16. The option valuation computer of claim 12 wherein the factor that reflects the propensity of the asset underlying the option to increase or decrease in value is determined by deriving the slope of a curve representing the historical performance over time of the stock of the corporation which is the basis for the option.

17. An option valuation server for valuing an option over a network, the option evaluation server comprising:
a processor,
a network to which the processor is connected,
a storage device connected to the process, and
a memory, the memory including software instructions, the software instructions comprising instructions for:
receiving over the network information relating to an option as required to determining an expected value using the Black-Scholes model;
adjusting the expected value by applying a factor to the expected value to reflect the propensity of the asset underlying the option to increase or decrease in value over time;
returning the expected value of the option as adjusted over the network.

18. The option valuation server for valuing an option over a network according to claim 17 wherein the network is selected from the group consisting of the Internet, intranet, local area networks (LANS), wide area networks (WANS), and a wireless network.

19. The option valuation server for valuing an option over a network according to claim 17 wherein the network comprises a plurality of interconnected networks.

20. The option valuation server of claim 17 wherein the instructions for adjusting the expected value by applying a factor to the expected value to reflect the propensity of the asset underlying the option to increase or decrease in value over time further comprises instructions for incorporating an additional argument into the Black-Scholes model.

21. The option valuation server of claim 17 wherein the instructions for adjusting the expected value by applying a factor to the expected value to reflect the propensity of the asset underlying the option to increase or decrease in value over time further comprises instructions for adjusting at least one variable of the Black-Scholes model.

22. The option valuation computer of claim 17 wherein the option is an option to buy or sell stock.

23. The option valuation computer of claim 17 wherein the option is an insurance policy.

24. The option valuation computer of claim 22 wherein the factor that reflects the propensity of the asset underlying the option to increase or decrease in value is determined by deriving the slope of a stock market index curve in which the underlying stock is listed.

25. The option valuation computer of claim 22 wherein the factor that reflects the propensity of the asset underlying the option to increase or decrease in value is determined by deriving the slope of an industry specific stock market index curve representing the industry of the corporation the stock of which is the basis for the option.

26. The option valuation computer of claim 22 wherein the factor that reflects the propensity of the asset underlying the option to increase or decrease in value is determined by deriving the slope of a curve representing the historical performance over time of the stock of the corporation which is the basis for the option.
